(19) United States
(12) Patent Application Publication
(10) Pub. No.: US 2005/0226523 A1
(43) Pub. Date: Oct. 13, 2005

(54) Augmenting a set of pixels

(76) Inventor: Dan M. Scott, Fort Worth, TX (US)

Correspondence Address: Steven Thrasher, 391 Sandhill Dr., Richardson, TX, 75080, US

(21) Appl. No.: 11/055,396

(22) Filed: Feb. 9, 2005

Related U.S. Application Data
(60) Provisional application No. 60/542,988, filed on Feb. 9, 2004.

(51) Int. Cl. G06K 9/48; G06K 9/40

(52) U.S. Cl. 382/254; 382/199

(57) ABSTRACT

The invention teaches the removal of unwanted features from an image, or the transformation of a region, by selectively expanding at least one region, and then selectively contracting the region. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CROSS REFERENCE TO RELATED APPLICATIONS

The invention is related to and claims priority from U.S. Provisional Patent Application No. 60/542,988, filed on 9 Feb. 2004, by Scott, et al., and entitled IMAGE ENHANCEMENTS.

### TECHNICAL FIELD OF THE INVENTION

The invention relates to at least geographic information system images.

### Problem Statement

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

A pixel-based image may be created directly as a pixel-based image, or indirectly as a scanned imaged (for example, an image may be scanned, rasterized and stored for viewing as a pixel-based image). For example, pixel-based flood maps, generated from images such as those available from the Federal Emergency Management Agency (FEMA), are created this way. Flood maps are typically expressed in a very limited number of pixel densities, or shades of gray, and have other properties known to those of skill in the flood map art.

Interestingly, images may have features that are sometimes unwanted, such as roads or text, and may have features expressed as stippling. Additionally, practically all images have features, blemishes, or other image shortcomings that are undesirable. Therefore, it would be advantageous to provide a system that gives a user the ability to remove image shortcomings, and to turn a less desirable feature expression, such as a feature expressed via stippling, into a more desirable feature expression, such as a region expressed as a color.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 is a pixel-based image.

FIG. 2 illustrates edge tracing and the selection of adjacent boundary pixels for augmentation.

FIG. 2b is a close-up of selected pixels of FIG. 2a used to more clearly illustrate features of FIG. 2a.

FIG. 3 shows the identification of pixels for augmentation.

FIG. 4 illustrates the expanded polygon region, and its complement.

FIG. 5 illustrates edge tracing and the selection of adjacent boundary pixels for augmentation in a complement region.

FIG. 6 shows the identification of selected boundary pixels.

FIG. 7 illustrates the pixel-based image having an expanded complement region.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### DESCRIPTION OF THE DRAWINGS

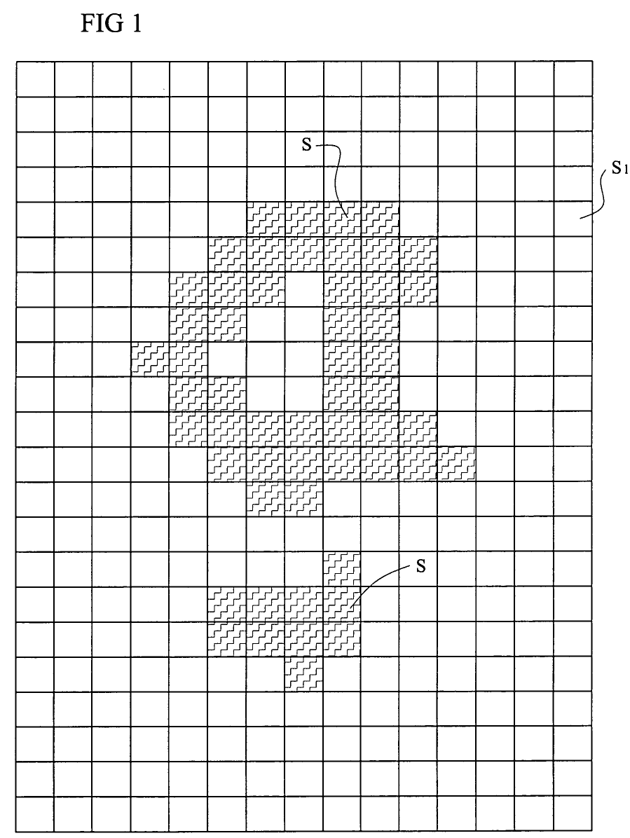

FIG. 1 is a pixel-based image such as a scanned map image or, more specifically, a scanned flood map image. Of course, the invention is not limited to scanned map images, as the image may be any pixel-based image, including scanned images, as will be readily understood by those of ordinary skill in the art upon reading this disclosure. The image comprises a first set of pixels S, and a set of pixels not in S, designated as S′ (although pixels in practice are a solid color, the pixels of S are shown here as having wiggly lines to distinguish them from pixels in S′, and at the same time enable the illustration of items helpful to the understanding of the invention). The definition of a set in FIG. 1 is exemplary, and the definition of a set or sets of pixels depends on the specific performance characteristics desired by a particular application, and is readily understood by those of skill in the art upon reading this disclosure.

From one perspective, the invention defines a method for removing a small feature or softening a boundary of a selected set of pixels, S, of a pixel-based image by selectively augmenting a set of pixels and then augmenting the inverse of that set. In practice, some boundary edges of S are identified by systematically examining the rightmost edge of each pixel of a scanned image. To do this, in the present example, each pixel in the scanned image of FIG. 1 is systematically examined to see if it is in the set S′, while the neighboring pixel to its right is in the set S.

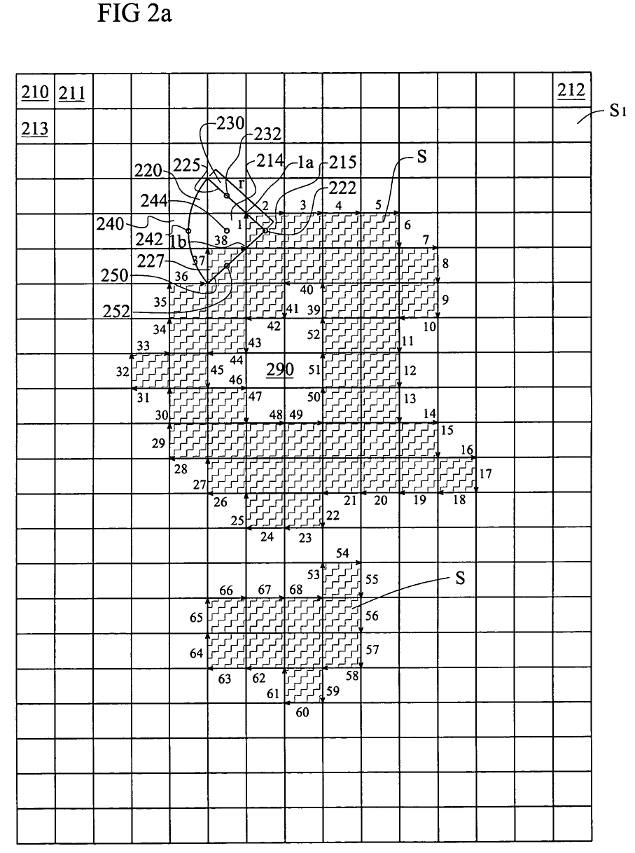

FIG. 2a illustrates edge tracing and the selection of adjacent boundary pixels for augmentation. FIG. 2b is a close-up of selected pixels of FIG. 2a used to more clearly illustrate features of FIG. 2a. Now, referring to both FIGS. 2a and 2b, the method searches for boundary edges by starting at the top left corner of the image at a first pixel 210 (which is in S′), and then progressing to the right one pixel 211 as the method seeks to detect a boundary edge by detecting a pixel in S (here, represented as a pixel of a different color). Eventually, the method reaches the top right pixel 212 without detecting a pixel in S. Then, the method returns to the next lowest row of pixels, beginning with pixel 213, and then proceeding to the right for the entire row. The method proceeds in a like manner until reaching pixel 214. Then, when pixel 215 is evaluated, it is determined to be in S.

Boundary edges are defined as pixel edges that form an interface between S and pixels not in S. Thus, it is determined that a first boundary edge (numbered 1 in FIGS. 2a and 2b and generally designated e) of S exist between the pixel 214 and the pixel 215. Here, it is worth noting that boundary pixels are defined as the pixels in S that have at least one boundary edge. Accordingly, upon discovering a previously undiscovered boundary edge, e, a path is traced from e to a boundary edge adjacent to e, e1 (edge 2 in FIG. 2a), and then tracing a path from e1 to a boundary edge adjacent to e1 (edge 3 in FIG. 2a), and repeating the act of tracing until a closed polygon is formed by returning to e. As each edge is traced, it is designated as “marked.” As the routine proceeds, each boundary edge is numbered as shown in FIG. 2a, where the first trace results in the numbered boundary edges 1 through 38.

Of interest, the direction of the trace is unimportant to the practice of the invention. For example, in FIG. 2a the edges are traced in a directional path such that pixels of the set S remain on the right hand side of the path as the edges are traced. Alternatively, the edges may be traced in a directional path such that pixels of the set S remain on the left hand side of the path as the edges are traced. In the present example, the figures are shown with the region being augmented to the right of the boundary as it is traced.

Next, the method proceeds to select pixels to include in the augmentation of S. In FIG. 2b, S is augmented by adding to S each pixel of S′ having a center point within a radius, r, of a center point of any of the boundary pixels. This can be thought of also as selecting the pixels that augment S as pixels of S′ having a center point within one of a set of hypothetical quarter circles (which can also look like “pie slices”). The hypothetical quarter circle having a center point 222 which functions as a vertex of a triangle formed by the edge 1 (the center point 222 is also the center point of the pixel 215—a boundary pixel). The hypothetical quarter circle 220 has a radius, r, a first side 225 with a length equal to the radius r, and a second side 227 with a length equal to the radius, r.

More specifically, the first side 225 is defined by a first ray having an origin at the center point 222 of the boundary pixel, and passes through a first end 1a of a boundary edge 1 of the pixel 215, and the second side 227 is defined by a second ray having an origin at the center point 222 of the boundary pixel 215, and passes through a second end 1b of the boundary edge 1 of the pixel 215.

Thus identified, it is seen in FIGS. 2a and 2b that the quarter circle 225 lies on at least the pixels 215, 214, 230, 240, and 250. Accordingly, center points 222, 232, 242, 244, and 252 lie within or on the quarter circle 225, and are thus identified as pixels of S′ for augmentation. The method then proceeds to generate a quarter circle encompassing the edge 2 to identify additional pixels of S′ for augmentation. Then, each additional boundary edge is evaluated until all the boundary edges of all the boundary pixels of S are evaluated to identify additional pixels of S′ for augmentation. Of course, since there is not a need to re-designate a pixel already designated for augmentation, there is a speed and processing advantage in limiting the evaluation of the pixels that may augment S to those pixels that have not been previously used to augment s, according to one method of the invention.

Either following the designation of the boundary edges and boundary pixels forming the first traced boundary of S, or following the identification of a first set of pixels in S′ designated for augmentation, the method proceeds with the pixel-by-pixel scan of the image to identify additional boundary edges. For example, in FIG. 2a, an edge 39 is identified by the transition from S′ to S, and then as the boundary edges are identified, boundary pixels are identified. Next, pixels of S′ designated for augmentation may be identified as described above, and generally define an expansion region of S′ 290. Afterwards, the method continues with step-wise scanning of the image until the boundary edge 53 is identified, and the method continues as discussed above.

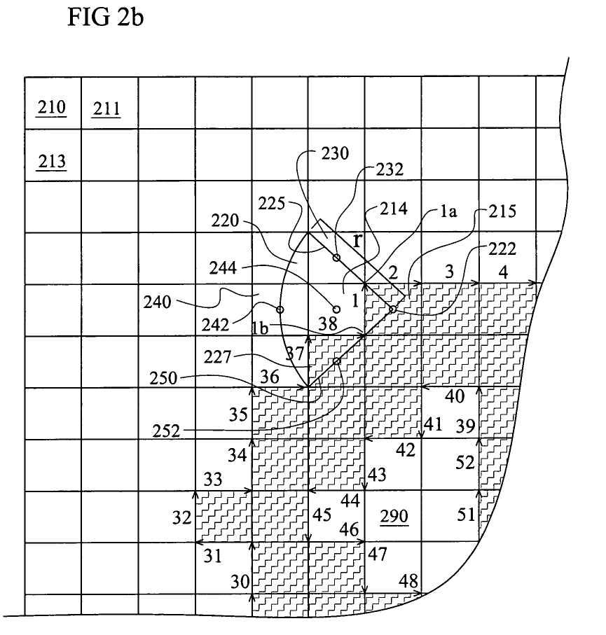

FIG. 3 shows the identification of pixels for augmentation. For illustrative purposes, each pixel selected for augmentation is identified by a number. That number corresponds with the number of the boundary edge that formed the cross-section of the quarter circle used to identify the center point of that pixel. Referring again to FIG. 2b, the quarter circle 225 identified pixels 230, 240, and 214 as augmentation pixels, and thus these pixels are identified by the number 1 in FIG. 3. Other augmentation pixels (or “expansion pixels”) are similarly identified. Next, S is augmented by assigning to S each of the augmentation pixels.

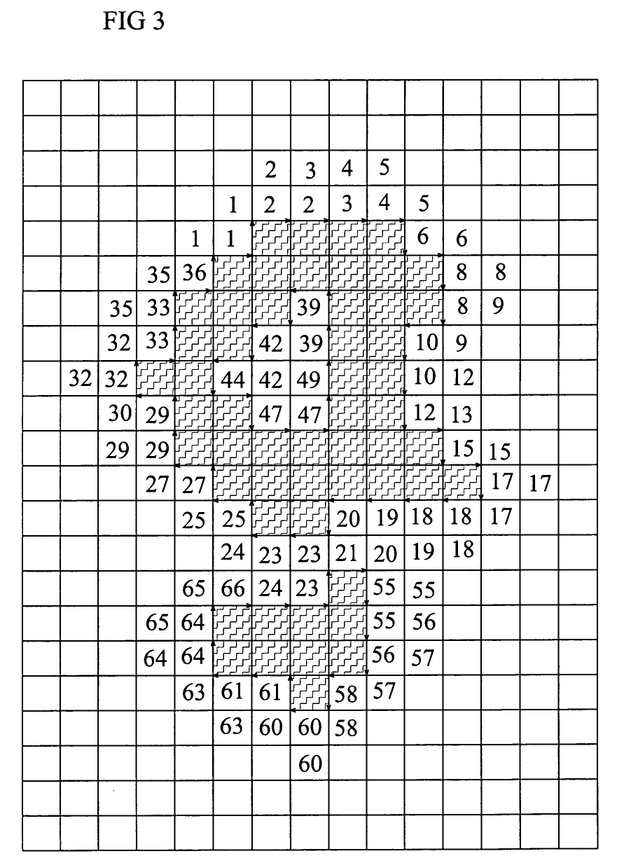

In the present example, the result appears in the pixel-based image as a single polygon, called an expanded polygon region. FIG. 4 illustrates the expanded polygon region S, and its complement S′. In one embodiment, the method denotes the augmented set as A(S, r) to illustrate dependence on both S, and a chosen augmentation radius, r. Additionally, the augmented set may be represented by defining a set T=A(S, r).

It is appreciated in the art that only augmenting an image results in an image with “ballooned” images. Accordingly, it is desired to “shrink” the expanded polygon(s), or, in other words, augment the complement (or inverse) of the just-augmented region. More specifically, T′ should be augmented.

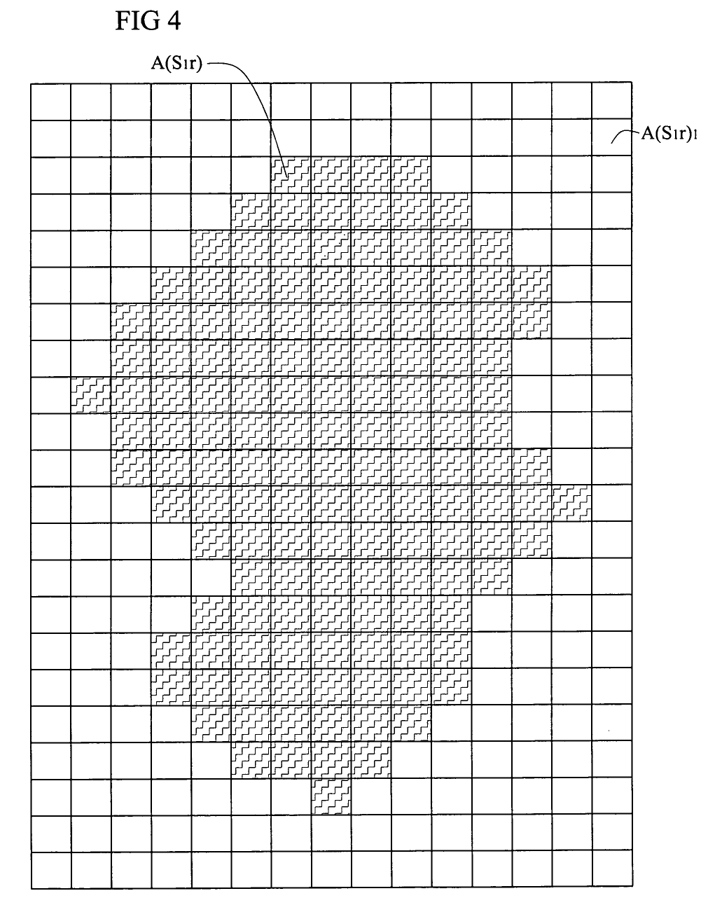

FIG. 5 illustrates edge tracing and the selection of adjacent boundary pixels for augmentation in a complement region T′. The method of identification of boundary edges and boundary pixels is discussed above, where the boundary edges are in FIG. 5 defined as pixel edges that form an interface between T′ and pixels not in T′ (in other words, in T). The resultant identification of boundary edges 1 through 68 is illustrated in FIG. 5. Similarly, boundary pixels of T′ are defined as the pixels in T′ that have at least one boundary edge. Next, T′ is augmented by using the quarter-circle method discussed above, and a quarter circle 525 is illustrated in FIG. 5 to assist with the identification of augmentation pixels in T. For example, the quarter circle 525 encompasses or touches the center points 532, 542, 552, and 562 of pixels 530, 540, 550, and 560 (not counting the origin point 512 of pixel 510).

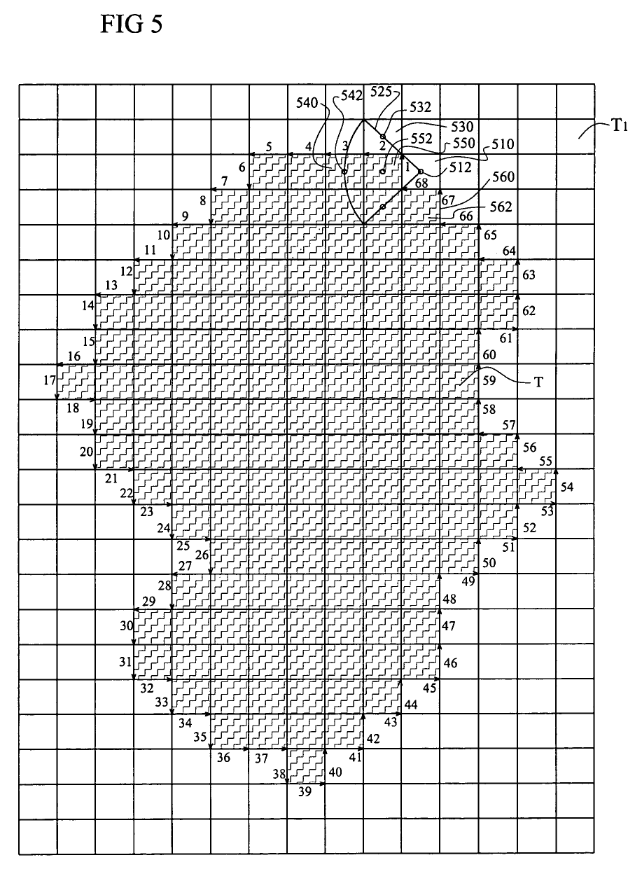

Accordingly T′ is augmented by adding to T′ each pixel of T having a center point within a radius, r, of a center point of any of the boundary pixels. The resulting pixels identified for augmentation are shown in FIG. 6. FIG. 6 shows the identification of pixels for augmentation, where the numbers in the pixels correspond with the number of the boundary edge that formed the cross-section of the quarter circle used to identify the center point of that pixel. Then, T′ is augmented to include each of the numbered pixels.

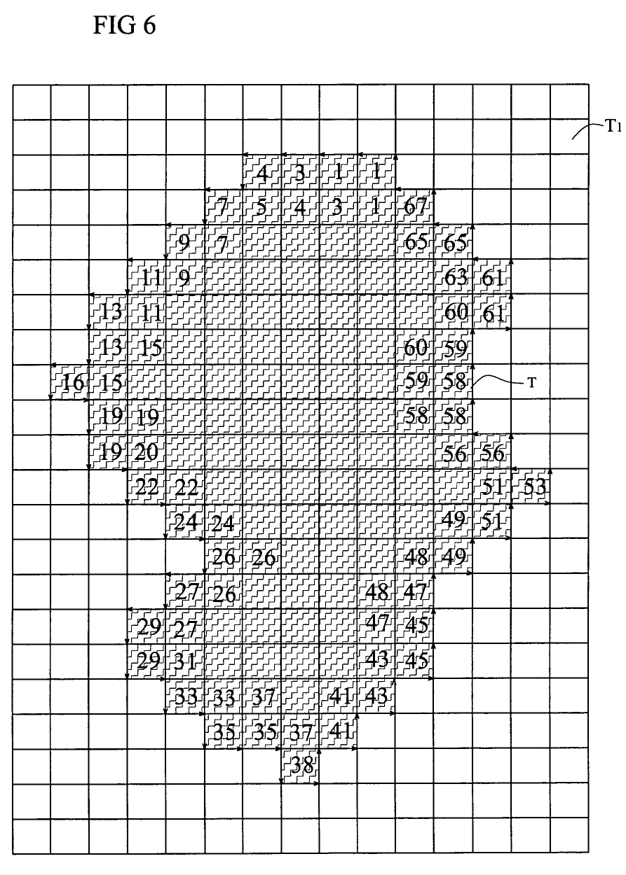

FIG. 7 illustrates the pixel-based image having an expanded complement region. The augmented set of T′ is denoted as W (W=A(T′, r)). Next, one may take W′, the complement of W, as the result. Accordingly, the invention has “converted” the image of FIG. 1 to the image of FIG. 7, thus eliminating the region 290, and uniting the pixels of S into a single region of pixels.

Of course, those of skill in the art may desire to achieve similar results using variations of the invention. For example, one may select to augment a region using a first radius r1 for a quarter circle, then augment the resulting complement region using a second radius r2 for a second quarter circle, where r2 is greater than r1. Then, one may augment the complement of the resulting region using yet a third radius r3 for a third quarter circle. In one embodiment, r2=r1+r3. The second augmented set may be denoted as W=A(T′, r2) to illustrate dependence on both T′, and a chosen augmentation radius. Similarly, the third augmented set W′, the complement of W, may be designated as set Q=A(W′, r3), where the set Q is defined as the result. Nevertheless, those of skill in the art will readily realize upon reading the present disclosure many variation and alternatives to the invention, without departing from the teachings of the invention or the claims.

Of course, it should be understood that the order of the acts of the algorithms discussed herein may be accomplished in different order depending on the preferences of those skilled in the art, and such acts may be accomplished as software or embedded hardware, and specific act may be performed by different pieces of hardware. Furthermore, though the invention has been described with respect to a specific preferred embodiment, many variations and modifications will become apparent to those skilled in the art upon reading the present application.

For example, the above-described methodology may be used to both remove unwanted roads, word, and other marks from a map image, while also identifying and shading stippled regions of a flood map image. It is therefore the intention that the appended claims and their equivalents be interpreted as broadly as possible in view of the prior art to include all such variations and modifications.

1. A method of augmenting a set, S, of pixels in a pixel-based image, comprising:
identifying boundary edges of S, where the boundary edges are defined as pixel edges that form an interface between S and the set of pixels not in S designated as S′;
identifying boundary pixels of S, where the boundary pixels are defined as the pixels in S that have at least one boundary edge; and
augmenting S by adding to S each pixel of S′ having a center point within a radius, r, of a center point of any of the boundary pixels.

2. The method of claim 1 wherein a boundary edge of S is identified by systematically examining a pixel in S′, and finding a second pixel, in S, immediately to the right of the first pixel.

3. The method of claim 1 further comprising identifying boundary edges, comprising:
discovering a previously undiscovered boundary edge, e,
tracing a path from e to a boundary edge adjacent to e, e1,
tracing a path from e1 to a boundary edge adjacent to e1,
repeating the act of tracing until a closed polygon is formed by returning to e, and
designating an edge as “marked” as it is traced.

4. The method of claim 3 wherein edges are traced in a directional path such that pixels of the set S remain on the right hand side of the path as the edges are traced.

5. The method of claim 3 wherein edges are traced in a directional path such that pixels of the set S remain on the left hand side of the path as the edges are traced.

6. The method of claim 1 wherein
the pixels that augment S are pixels of S′ having a center point within a hypothetical quarter circle,
the hypothetical quarter circle having a center point,
the center point is also the center point of a boundary pixel of S,
the hypothetical quarter circle has a radius, r, a first side and a second side,
the first side is defined by a first ray having an origin at the center point of the boundary pixel, and passes through a first end of a boundary edge of the boundary pixel, and
the second side is defined by a second ray having an origin at the center point of the boundary pixel, and passes through a second end of the boundary edge of the boundary pixel.

7. The method of claim 6 wherein the pixels that augment S are limited to those pixels that have not been previously used to augment S.

8. The method of claim 1 wherein the image is a scanned map image.

9. The method of claim 8 wherein the scanned map image is a scanned flood map image.

10. The method of claim 1 further comprising first surrounding the pixel-based image with additional pixels to form a new pixel-based image, such that the outer edge of the new pixel-based image is comprised completely of pixels in S′.

11. A method for softening a boundary of a selected set of pixels, S, of a pixel-based image, and removing small features from the complement of S, comprising:
augmenting the set S by
identifying boundary edges of S, where the boundary edges are defined as pixel edges that form an interface between S and pixels not in S designated as S′;
identifying boundary pixels of S, where the boundary pixels are defined as the pixels in S that have at least one boundary edge; and
augmenting S by adding to S each pixel of S′ having a center point within a radius, r, of a center point of any of the boundary pixels
denoting the augmented set as A(S, r) to illustrate dependence on both S, and a chosen augmentation radius, r;
defining a set T=A(S, r);
augmenting T′ by
identifying boundary edges of T′, where the boundary edges are defined as pixel edges that form an interface between T′ and pixels in T;
identifying boundary pixels of T′, where the boundary pixels are defined as the pixels in T′ that have at least one boundary edge;
augmenting T′ by adding to T′ each pixel of T having a center point within a radius, r, of a center point of any of the boundary pixels;
denoting the augmented set of T′ as W, W=A(T′, r); and
taking W′, the complement of W, as the result.

12. A method for removing small features from, and softening the boundary of, a selected set of pixels, S, and a complement set of pixels, S′, of a pixel-based image, comprising:
augmenting the set S by
identifying boundary edges of S, where the boundary edges are defined as pixel edges that form an interface between S and pixels not in S;
identifying boundary pixels of S, where the boundary pixels are defined as the pixels in S that have at least one boundary edge;
augmenting S by adding to S each pixel of S′ having a center point within a radius, r1, of a center point of any of the boundary pixels;
denoting the augmented set as A(S, r1) for illustrating dependence on both S, and a chosen augmentation radius, r1
defining a set T=A(S, r1);
augmenting T′, by
identifying boundary edges of T′, where the boundary edges are defined as pixel edges that form an interface between T′ and pixels in T;
identifying boundary pixels of T′, where the boundary pixels are defined as the pixels in T′ that have at least one boundary edge;
augmenting T′ by adding to T′ each pixel of T having a center point within a radius, r2, of a center point of any of the boundary pixels;
denoting the augmented set as W=A(T′, r2) to illustrate dependence on both T′, and a chosen augmentation radius, r2;
augmenting W′, the complement of W, to obtain a set Q=A(W′, r3); and
defining the set Q as the result.
